(19) United States
(12) Patent Application Publication
(10) Pub. No.: US 2025/0234338 A1
(43) Pub. Date: Jul. 17, 2025

(54) RESOURCE DELIVERY FOR PEER TO PEER GROUP

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Plano, TX (US); Yue Qi, Plano, TX (US)

(21) Appl. No.: 19/007,360

(22) Filed: Dec. 31, 2024

Related U.S. Application Data
(60) Provisional application No. 63/620,063, filed on Jan. 11, 2024.

(51) Int. Cl. H04W 72/04; H04W 92/18

(52) U.S. Cl. CPC H04W 72/04; H04W 92/18

(57) ABSTRACT

A first station (STA) in a wireless network obtains authorization, from a peer to peer (P2P) group, to transmit a request frame to an access point (AP) on behalf of the P2P group. The first AP is a member of the P2P group. The first STA transmits, to an AP, a request frame that requests a resource from the AP on behalf of the P2P group. The first STA is associated with the AP.

### CROSS REFERENCE TO RELATED APPLICATION

This application claims benefit of U.S. Provisional Application No. 63/620,063, entitled “Resource Delivery Mechanism for P2P Groups,” filed on Jan. 11, 2024, in the United States Patent and Trademark Office, the entire contents of which are hereby incorporated by reference.

### TECHNICAL FIELD

This disclosure relates generally to a wireless communication system, and more particularly to, for example, but not limited to, peer-to-peer (P2P) communication in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide a mechanism and protocol for an access point (AP) to deliver channel resources to a peer-to-peer (P2P) group.

An aspect of the disclosure provides an access point (AP) in a wireless network. The AP comprises a memory and a processor. The process is coupled to the memory. The processor is configured to receive, from a first station (STA), a request frame that solicits a channel resource from the AP on behalf of a peer to peer (P2P) group, wherein the first STA is associated with the AP. The processor is further configured to transmit, to the first STA, a response frame corresponding to the request frame. The processor is further configured to allocate, to one or more STAs to which belong to the P2P group, the solicited channel resource in response to the request frame.

In an embodiment, the request fame is a stream classification service (SCS) request frame, and the response frame is an SCS response frame.

In an embodiment, the response frame includes an indication that the AP accepts the request.

In an embodiment, the response frame includes information indicating the P2P group.

In an embodiment, the request frame solicits the channel resource from the AP on behalf of a subset of the P2P group.

In an embodiment, the allocating the solicited channel resource comprises transmitting a trigger frame that allocates a portion of the channel resource to the one or more STAs.

In an embodiment, the trigger frame includes one or more identifiers corresponding to the one or more STAs or an identifier of the P2P group.

In an embodiment, the trigger frame includes a broadcast address and one more identifiers corresponding to the one more STAs or an identifier of the P2P group.

In an embodiment, the trigger frame indicates that a portion of the channel resource is to be used by a particular STA.

In an embodiment, the response frame indicates that the AP supports a resource sharing process for the P2P group.

An aspect of the disclosure provides a first station (STA) in a wireless network. The first STA comprises a memory and a processor. The processor is coupled to the memory. The processor is configured to transmit, to an access point (AP), a request frame that solicits a channel resource from the AP on behalf of a peer to peer (P2P) group, wherein the first STA is associated with the AP and a member of the P2P group. The processor is further configured to receive, from the AP, a response frame indicating acceptance to the request.

In an embodiment, the processor is further configured to cause receiving, from the AP, the solicited channel resource.

In an embodiment, the processor is further configured to cause receiving, from the AP, a trigger frame that allocates a portion of the channel resource to the first STA.

In an embodiment, the trigger frame indicates that a portion of the channel resource is to be used by a particular STA.

In an embodiment, the response frame includes information indicating the P2P group.

In an embodiment, the request frame solicits the channel resource from the AP on behalf of a subset of the P2P group.

In an embodiment, the request frame indicates that the first STA supports a resource sharing process for the P2P group.

An aspect of the disclosure provides a method performed by an access point (AP). The method comprises receiving, from a first station (STA), a request frame that solicits a channel resource from the AP on behalf of a peer to peer (P2P) group, wherein the first STA is associated with the AP. The method further comprises transmitting, to the first STA, a response frame corresponding to the request frame. The method further comprises allocating, to one or more STAs to which belong to the P2P group, the solicited channel resource in response to the request frame.

In an embodiment, the request frame solicits the channel resource from the AP on behalf of a subset of the P2P group.

In an embodiment, the allocating the solicited channel resource comprises transmitting a trigger frame that allocates a portion of the channel resource to the one or more STAs.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example network in accordance with an embodiment.

FIG. 5 shows an example scenario of an AP allocating TXOP to multiple P2P STAs in a multi-casting manner.

FIG. 6 shows an example scenario of an AP allocating channel resources to a P2P group.

FIG. 7 shows an example scenario of an AP allocating TXOP to P2P STAs indicating portions of the TXOP.

FIG. 8 shows an example process in accordance with an embodiment.

FIG. 9 shows an example process in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to a wireless communication system, and more particularly, to a Wireless Local Area Network (WLAN) technology. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

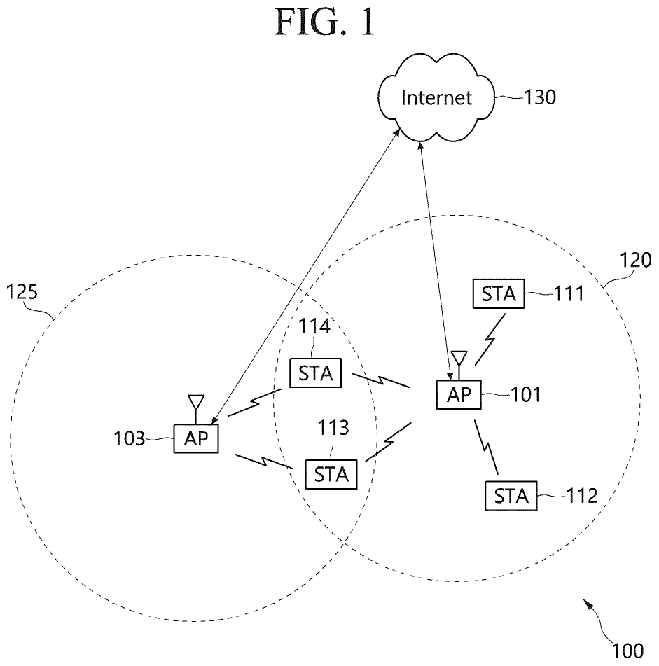

FIG. 1 shows an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

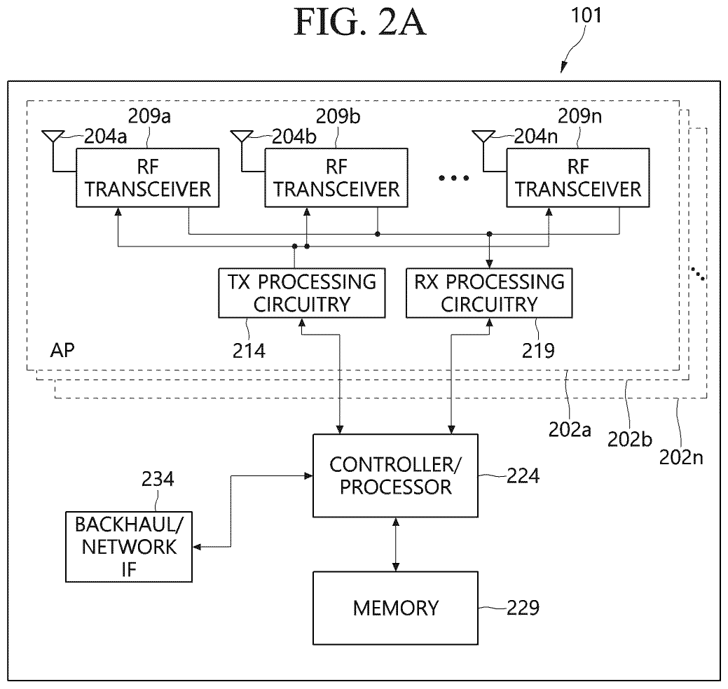

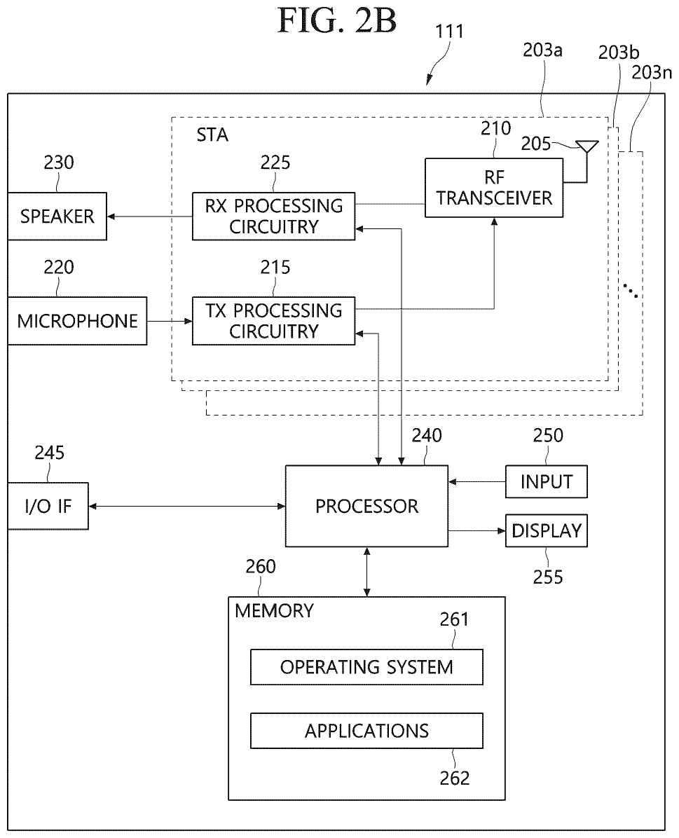

FIG. 2A shows an example AP 101 according to this disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

As shown in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

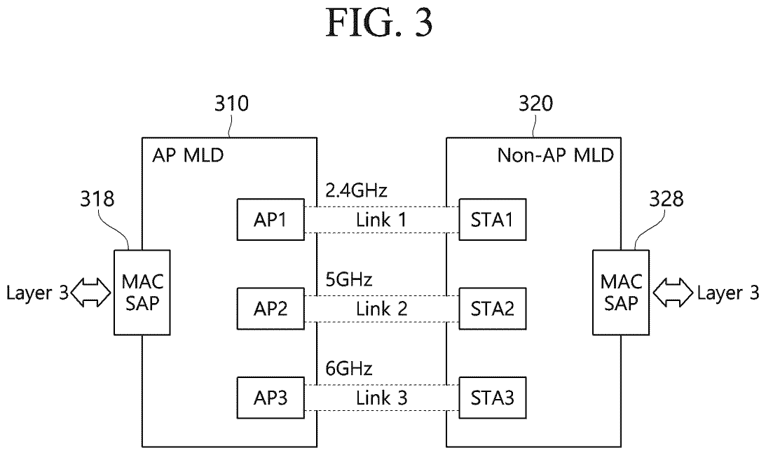

FIGS. 2 and 3 illustrate example electronic devices in accordance with an embodiment of this disclosure. In particular, FIG. 2 shows an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions.

For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A shows one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B shows an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B shows the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.0, “Wireless LAN Medium Access Control (MAC) and Physical Layer (PHY) Specifications.”

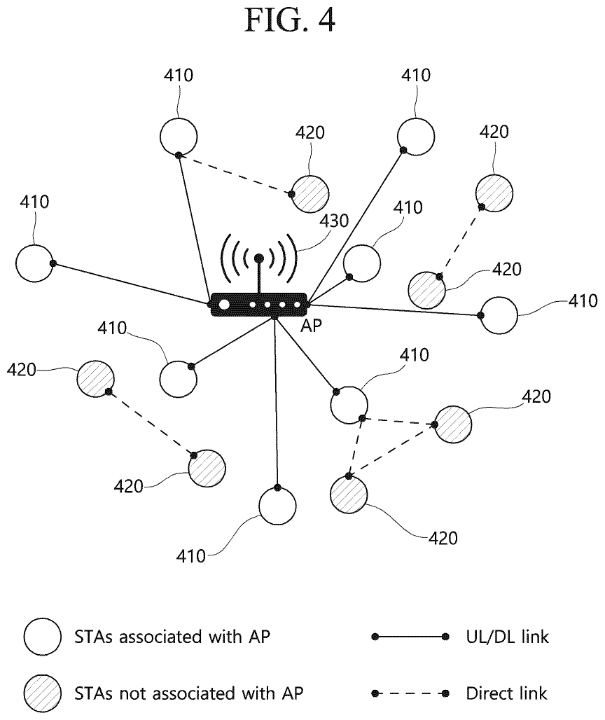

FIG. 4 shows an example network in accordance with an embodiment. The network depicted in FIG. 4 is for explanatory and illustration purposes. FIG. 4 does not limit the scope of this disclosure to any particular implementation.

In FIG. 4, a plurality of STAs 410 may be non-AP STAs associated with AP 430, and a plurality of STAs 420 may be non-AP STAs which are not associated with AP 430. Additionally, solid lines between STAs represent uplink or downlink with AP 430, while the dashed lines between STAs represent a direct link between STAs.

Next generation WLAN system needs to provide improved support for low-latency applications. Today, it is common to observe numerous devices operating on the same network as shown in FIG. 4. Many of these devices may have a tolerance for latency, but still compete with the devices running low-latency applications for the same time and frequency resources. In some cases, the AP 430 as a network controller may not have enough control over the unregulated or unmanaged traffic that contends with the low-latency traffic within the infrastructure basic service set (BSS). In some embodiments, the infrastructure BSS is a basic service set that includes an AP 430 and one or more non-AP STAs 410, while the independent BSS is a basic service set where non-AP STAs 420 communicate with each other without the need for a centralized AP. Some of the unregulated or unmanaged traffic that interferes with the latency-sensitive traffic in the BSS of the AP may originate from uplink, downlink, or direct link communications within the infrastructure BSS that the AP manages. Another source of the interference may be transmission from the neighboring infrastructure OBSS (Overlapping Basic Service Set), while others may come from neighboring independent BSS or peer to peer (P2P) networks. Therefore, the next generation WLAN system needs mechanisms to more effectively handle unmanaged traffic while prioritizing low-latency traffic in the network.

In an embodiment, an AP may receive, from a first STA, a request to allocate at least one resource on behalf of a P2P group. The first STA may be a member of the P2P group. If the AP receives, from the first STA, a request to allocate resources on behalf of the P2P group then the AP may either accept the request, reject the request, or suggest some alternative parameters for the resource delivery schedule for the P2P group.

In an embodiment, an AP may receive, from a first STA, a request frame that indicates a request to allocate resources on behalf of a P2P group. The first STA may be a member of the P2P group. The request frame may be a stream classification service (SCS) request frame. If the AP receives, from the first STA, an SCS request frame that indicates a request to allocate resources on behalf of a P2P group then the AP may transmit, to the first STA, an SCS response frame to indicate that the AP accepts the request, rejects the request, or suggest some alternative SCS parameters for the resource delivery schedule for the P2P group.

In an embodiment, an AP may transmit, to a STA, a response frame corresponding to a request frame that requests an allocation of at least one resource on behalf of a P2P group. The response frame may be an SCS response frame and the request frame may be an SCS request frame. The resource to be allocated may be a transmission opportunity (TXOP). If the AP transmits, to the STA, an SCS Response frame corresponding to an SCS Request frame that requests an TXOP on behalf of a P2P group, then the AP may indicate, in the response frame, some identifier that identifies the P2P group. The identifier may be, for example and without limitation, a P2P group identifier (ID) or neighbor awareness networking (NAN) cluster ID.

In an embodiment, an AP may accept a request to deliver channel resources to at least one STA that is a member of a P2P group. If the AP accepts the request to deliver channel resources to at least one STA that is a member of the P2P group, then the AP may deliver channel resources to the STA(s) following a schedule requested for in the accepted request. The channel resources may be a TXOP.

In an embodiment, an AP may accept, from a first STA, a request frame soliciting channel resources on behalf of a P2P group. Subsequently, the AP may transmit a response frame indicating the acceptance. The request frame may be an SCS Request frame, and the response frame may be an SCS Response frame. The channel resources may be a TXOP. If the AP accepts an SCS Request frame from the first STA soliciting TXOP on behalf of the P2P group, and the AP transmits an SCS Response frame indicating the acceptance, then the AP may deliver the TXOP to members of the P2P group or a subset of the members of the P2P group following a schedule requested for the P2P group as per SCS parameters included in the SCS Request frame.

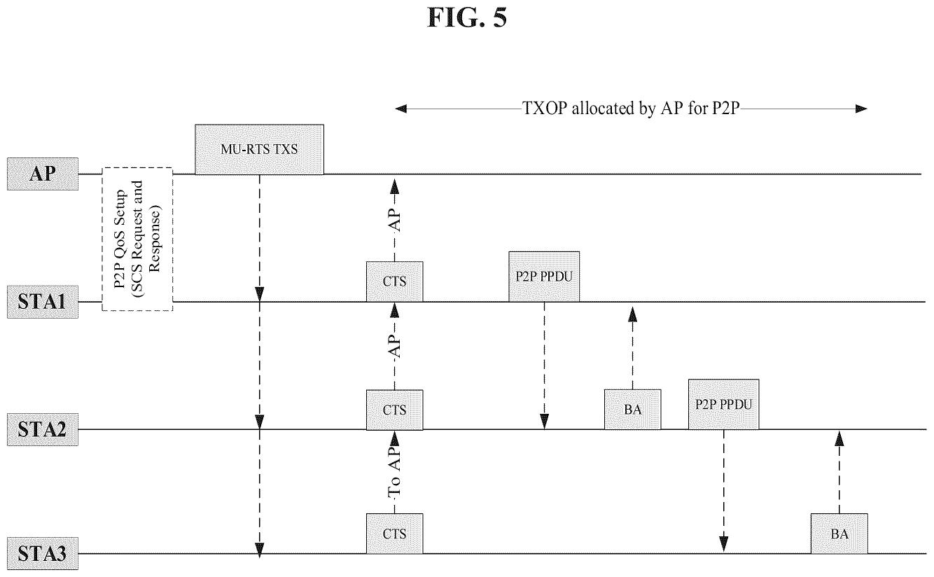

In an embodiment, an AP may deliver TXOP to a P2P group by transmitting a trigger frame. The trigger frame may be a multiuser ready to send (MU-RTS) triggered TXOP sharing (TXS) Trigger frame. In this disclosure, the TXS procedure allows an AP to allocate a portion of an obtained TXOP to one or more associated non-AP STAs. The AP may transmit the trigger frame in a multi-case manner such as transmitting to specific STAs in the P2P group. The User Info field of the trigger frame may list the association identifier (AID) values for those STAs. The AP may allocate TXOP to those STAs for their P2P communication as shown in FIG. 5.

FIG. 5 shows an example scenario of an AP allocating TXOP to multiple P2P STAs in a multi-casting manner.

Referring to FIG. 5, the AP may have received, from STA1, an SCS request and transmitted, to STA1, an SCS response establishing a P2P quality of service (QoS) expectation. STA1, STA2 and STA3 are members of a P2P group. The AP transmits a trigger frame to STA1, STA2 and STA3 allocating a TXOP for P2P transmission where the trigger frame is a MU-RTS TXS Trigger frame. Subsequently, STA1, STA2 and STA3 each receives, from the AP, the trigger frame and respond by each transmitting, to the AP, a clear to send (CTS) acknowledgement. STA1 transmits, to STA2, a P2P physical layer (PHY) protocol data unit (PPDU) using the TXOP. STA2 receives, from STA1, the P2P PPDU and responds by transmitting, to STA1 a block acknowledgement (BA). Subsequently, STA2 transmits, to STA3, a P2P PPDU using the TXOP. STA3 then receives, from STA2, the P2P PPDU and responds by transmitting, to STA2, a BA.

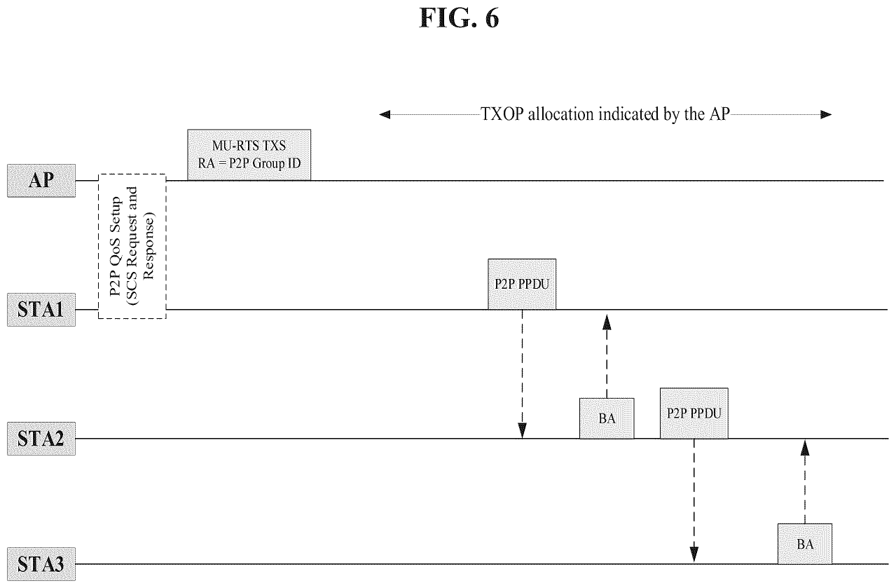

In an embodiment, the AP may deliver a TXOP to a P2P group by transmitting a trigger frame. The P2P group may have a P2P group ID. The trigger frame may be an MU-RTS TXS Trigger frame. The AP may transmit the trigger frame on a P2P group basis. The receiver address (RA) field may be set as a broadcast address, and The User Info field may be set to the P2P Group ID. The AP may transmit a trigger frame to allocate a TXOP to those STAs for their P2P communication as shown in FIG. 6. In another embodiment, the group RA field of the trigger frame may be set to the P2P Group ID.

FIG. 6 shows an example scenario of an AP allocating channel resources to a P2P group.

Referring to FIG. 6, the AP may have received, from STA1, an SCS request and transmitted, to STA1, an SCS response establishing a P2P QoS expectation. STA1, STA2, and STA3 are members of a P2P group. The AP transmits a trigger frame to the P2P group where the trigger frame is a MU-RTS TXS Trigger frame allocating TXOP to the P2P group. The RA field of the MU-RTS TXS Trigger frame is set to the P2P Group ID of the P2P group. STA1 may receive, from the AP, the trigger frame if the P2P Group ID was set as one of STA1's link addresses. Subsequently, STA1 transmits, to STA2, a P2P PPDU using the TXOP. STA2 receives, from STA1, the P2P PPDU and responds by transmitting, to STA1, a BA. Subsequently, STA2 transmits, to STA3, a P2P PPDU using the TXOP. STA3 receives, from STA2, the P2P PPDU and responds by transmitting, to STA2, a BA.

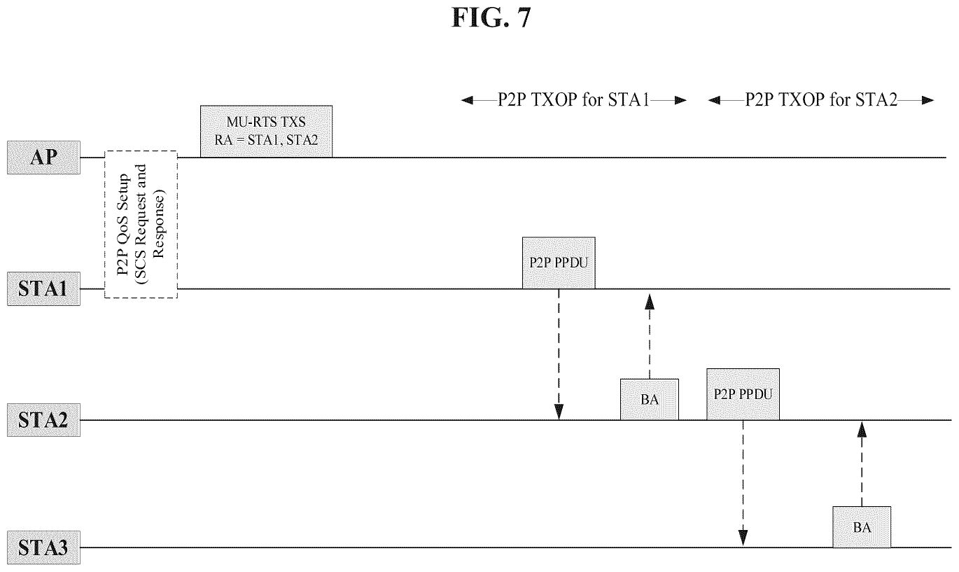

In an embodiment, an AP may indicate which portion of the TXOP is to be used by which P2P STA as shown in FIG. 7. The AP may indicate the portion to be used by a STA in the Duration field of the trigger frame.

FIG. 7 shows an example scenario of an AP allocating TXOP to P2P STAs indicating portions of the TXOP.

Referring to FIG. 7, the AP may have received, from STA1, an SCS request and transmitted, to STA1, an SCS response establishing a P2P QoS expectation. STA1, STA2, and STA3 are members of a P2P group. The AP transmits a trigger frame to the P2P group where the trigger frame is a MU-RTS TXS Trigger frame allocating TXOP to the P2P group. The RA field of the MU-RTS TXS Trigger frame is set to the STA1 and STA2 indicating that a portion of the P2P TXOP is for STA1 and that another portion of the P2P TXOP is for STA2. STA1 and STA2 may receive, from the AP, the trigger frame. Subsequently, STA1 transmits, to STA2, a P2P PPDU using the P2P TXOP for STA1. STA2 receives, from STA1, the P2P PPDU and responds by transmitting, to STA1, a BA. Subsequently, STA2 transmits, to STA3, a P2P PPDU using the P2P TXOP for STA2. STA3 receives, from STA2, the P2P PPDU and responds by transmitting, to STA2, a BA.

In an embodiment, a STA may support a TXOP sharing process for a P2P group. The STA may indicate its TXOP sharing capability to an associated AP during its association with AP or after its association with the AP. The AP may indicate the TXOP sharing capability to the associated AP by setting a bit in the ultra-high reliability (UHR) Control field of a request frame, setting a bit in a Probe Request frame or setting a bit using some other elements in a frame transmitted to the associated AP.

In an embodiment, an AP may support a TXOP sharing process for a P2P group. The AP may be part of a basic service set with STAs. The AP may indicate its TXOP sharing capability to the STAs in the BSS. The AP may indicate the TXOP sharing capability to the STAs in the BSS by including a capability indication in a Beacon frame, a Probe Response frame or an Association Response frame.

In an embodiment, a STA may not transmit an SCS Request frame on behalf of a P2P group to an associated AP if the AP does not support this feature.

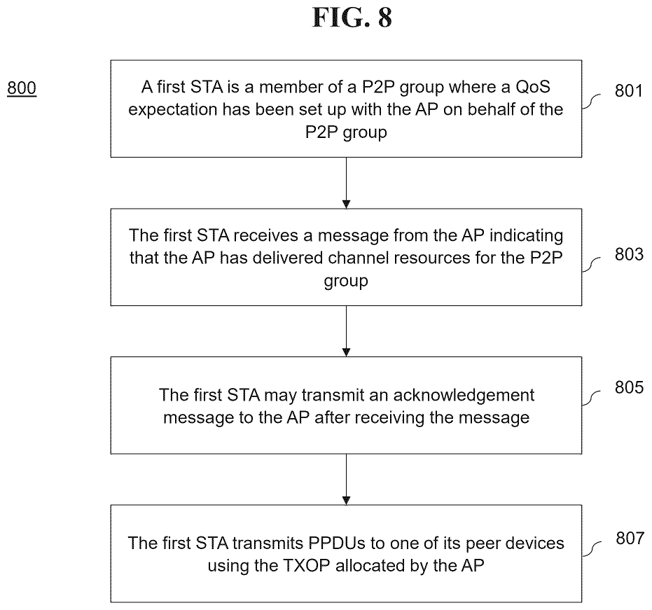

FIG. 8 shows an example process 800 in accordance with an embodiment. Although one or more operations are described or shown in particular sequential order, in other embodiments the operations may be rearranged in a different order, which may include performance of multiple operations in at least partially overlapping time periods. The process 800 may be performed in a STA.

In FIG. 8, a STA-side procedure for actions after receiving P2P group TXOP. FIG. 8 is exemplary and shall not be deemed to constitute a limitation on this disclosure.

The process 800 may begin in operation 801. In operation 801, a first STA is a member of a P2P group where a QoS expectation has been set up with the AP on behalf of the P2P group.

In operation 803, the first STA receives a message from the AP indicating that the AP has delivered channel resources for the P2P group. In an embodiment, the message may be a trigger frame. In an embodiment, the channel resources may be TXOP.

In operation 805, the first STA may transmit an acknowledgement message to the AP after receiving the message.

In operation 807, the first STA transmits PPDUs to one of its peer devices using the TXOP allocated by the AP.

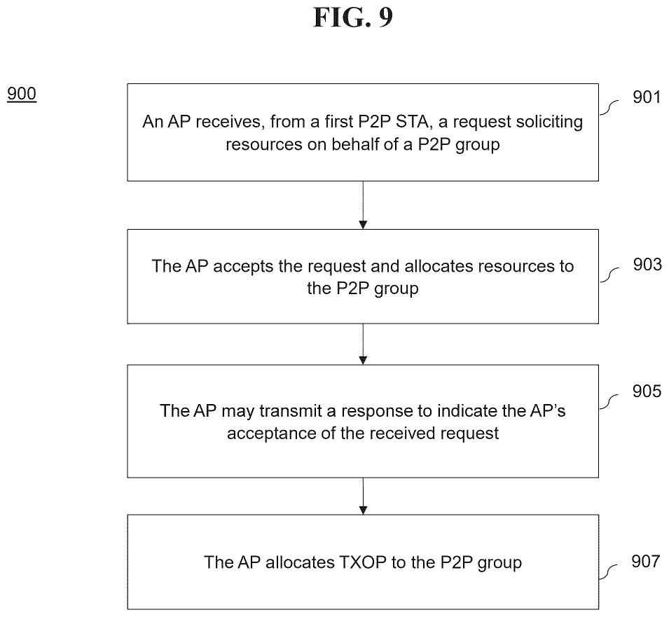

FIG. 9 shows an example process 900 in accordance with an embodiment. Although one or more operations are described or shown in particular sequential order, in other embodiments the operations may be rearranged in a different order, which may include performance of multiple operations in at least partially overlapping time periods. The process 900 may be performed in a STA.

In FIG. 9, a STA-side procedure for delivering TXOP to a P2P group. FIG. 9 is exemplary and shall not be deemed to constitute a limitation on this disclosure.

The process 900 may begin in operation 901. In operation 901, an AP receives, from a first P2P STA, a request soliciting resources on behalf of a P2P group.

In operation 903, the AP accepts the request and allocates resources to the P2P group. The resources may be TXOP for P2P transmission.

In operation 905, the AP may transmit, to the first P2P STA, a response indicating the AP's acceptance of the received request.

In operation 907, the AP allocates TXOP to the P2P group. When the AP allocates TXOP to a P2P group it is allocating the solicited resource to P2P STAs of the P2P group according to the SCS Request frame's parameters. The AP allocates TXOP by transmitting a MU-RTS TXS Trigger frame and indicates in the RA field the P2P Group ID. The AP may allocate the TXOP based on the traffic pattern indicated in the SCS Request frame. In an embodiment, the AP may also indicate a subset of P2P STAs for which the TXOP has been allocated.

In an embodiment, an AP may receive, from an associated non-AP STA (first STA), a message where the message indicates a request for channel resources for P2P communication. The message may include an indication that the requested channel resources be in the form of TXOP or medium time/air time. The message may also indicate that the resource request is for a P2P group in which the first STA is a member and other non-AP STAs that are also members of the P2P group may utilize the requested channel resources for their P2P communication. The AP may transmit, to the first STA, a trigger frame after receiving, from the first STA, the message if the AP accepts the request in the message. The AP may indicate, in the trigger frame, allocation of the requested TXOP to the P2P group. The trigger frame may be a new version of the MU-RTS TXS trigger frame.

In an embodiment, the AP may include, in the trigger frame, an identifier that may be unique to the P2P group such as a P2P group ID. The AP may transmit the trigger frame as a broadcast or multi-cast frame. The AP may allocate a resource such as TXOP to a STA by transmitting the trigger frame. A P2P STA that is a member of the P2P group may receive the trigger frame. The P2P STA may then utilize the TXOP allocated for its P2P communication. In an embodiment, the P2P group ID may also be the MAC address of the first STA.

In an embodiment, an AP may set the STA ID field in the trigger frame as the association identifier (AID) of a first non-AP STA that has transmitted, to the AP, a resource request on behalf of a P2P group. The first non-AP STA may be a member of the P2P group. The AP may also include in the trigger frame an indication that the TXOP allocated by the trigger frame may be accessed by another non-AP STA that is a member of the P2P group.

In an embodiment, an AP may transmit, to a first STA, a trigger frame in response to a request frame received, from the first STA, soliciting a resource on behalf of a P2P group which the first STA is a member of. The AP may transmit a trigger frame as a broadcast or multi-cast frame. The AP may allocate a resource such as TXOP to a STA by transmitting the trigger frame. The AP may set the RA field of the trigger frame as the broadcast address. A P2P STA may receive, from the AP, the trigger frame. The P2P STA may then utilize the TXOP allocated for its P2P communication.

This disclosure provides a mechanism for APs to deliver solicited resources by transmitting response frames and then trigger frames to P2P groups. This mechanism permits an AP to deliver solicited resources to multiple STAs that are members of a P2P group in response to a request on behalf of a P2P group.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) in a wireless network, comprising:
a memory; and
a processor coupled to the memory, the processor configured to cause:
receiving, from a first station (STA), a request frame that solicits a channel resource from the AP on behalf of a peer to peer (P2P) group, wherein the first STA is associated with the AP;
transmitting, to the first STA, a response frame corresponding to the request frame; and
allocating, to one or more STAs to which belong to the P2P group, the solicited channel resource in response to the request frame.

2. The AP of claim 1, wherein the request fame is a stream classification service (SCS) request frame, and the response frame is an SCS response frame.

3. The AP of claim 1, wherein the response frame includes an indication that the AP accepts the request.

4. The AP of claim 1, wherein the response frame includes information indicating the P2P group.

5. The AP of claim 1, wherein the request frame solicits the channel resource from the AP on behalf of a subset of the P2P group.

6. The AP of claim 1, wherein the allocating the solicited channel resource comprises transmitting a trigger frame that allocates a portion of the channel resource to the one or more STAs.

7. The AP of claim 6, wherein the trigger frame includes one or more identifiers corresponding to the one or more STAs or an identifier of the P2P group.

8. The AP of claim 6, wherein the trigger frame includes a broadcast address and one more identifiers corresponding to the one more STAs or an identifier of the P2P group.

9. The AP of claim 6, wherein the trigger frame indicates that a portion of the channel resource is to be used by a particular STA.

10. The AP of claim 1, wherein the response frame indicates that the AP supports a resource sharing process for the P2P group.

11. A first station (STA) in a wireless network, comprising:
a memory; and
a processor coupled to the memory, the processor configured to cause:
transmitting, to an access point (AP), a request frame that solicits a channel resource from the AP on behalf of a peer to peer (P2P) group, wherein the first STA is associated with the AP and a member of the P2P group; and
receiving, from the AP, a response frame indicating acceptance to the request.

12. The first STA of claim 11, wherein the processor is further configured to cause receiving, from the AP, the solicited channel resource.

13. The first STA of claim 11, wherein the processor is further configured to cause receiving, from the AP, a trigger frame that allocates a portion of the channel resource to the first STA.

14. The first STA of claim 13, wherein the trigger frame indicates that a portion of the channel resource is to be used by a particular STA.

15. The first STA of claim 11, wherein the response frame includes information indicating the P2P group.

16. The first STA of claim 11, wherein the request frame solicits the channel resource from the AP on behalf of a subset of the P2P group.

17. The first STA of claim 11, wherein the request frame indicates that the first STA supports a resource sharing process for the P2P group.

18. A method performed by an access point (AP), the method comprising:
receiving, from a first station (STA), a request frame that solicits a channel resource from the AP on behalf of a peer to peer (P2P) group, wherein the first STA is associated with the AP;
transmitting, to the first STA, a response frame corresponding to the request frame; and
allocating, to one or more STAs to which belong to the P2P group, the solicited channel resource in response to the request frame.

19. The method of claim 18, wherein the request frame solicits the channel resource from the AP on behalf of a subset of the P2P group.

20. The method of claim 18, wherein the allocating the solicited channel resource comprises transmitting a trigger frame that allocates a portion of the channel resource to the one or more STAs.
